(19) United States
(12) Patent Application Publication
(10) Pub. No.: US 2015/0271647 A1
(43) Pub. Date: Sep. 24, 2015

(54) SYSTEMS AND METHODS FOR ALTERING MOVEMENT OF MOBILE COMMUNICATION DEVICES BASED ON DETERMINED MOVEMENTS

(71) Applicant: Lenovo Enterprise Solutions (Singapore) PTE. LTD., Singapore (SG)

(72) Inventors: William M. Megarity, Raleigh, NC (US); Luke D. Remis, Raleigh, NC (US); Gregory D. Sellman, Morrisville, NC (US); Christopher L. Wood, Greenville, NC (US)

(21) Appl. No.: 14/221,782

(22) Filed: Mar. 21, 2014

(51) Int. Cl. H04W 4/04; H04M 19/04

(52) U.S. Cl. CPC H04W 4/04; H04M 19/047; H04M 2250/12

(57) ABSTRACT

Systems and methods for altering movement of mobile communication devices based on determined movements are disclosed. According to an aspect, a method may include determining movement of a mobile communication device. The method may also include determining whether the movement of the mobile communication device meets a predetermined criterion. Further, the method may include controlling a mechanism of the mobile communication device for altering movement of the mobile communication device in response to determining that the movement meets the predetermined criterion.

### BACKGROUND

1. Field of the Invention

The present invention relates to altering movements of electronic devices, and more specifically, to systems and methods for altering movement of mobile communication devices based on determined movements.

2. Description of Related Art

Mobile communication devices generally include functionality for notifying a user of an incoming communication or other information. For example, a smartphone or other type of mobile telephone may ring or vibrate in response to receipt of an incoming call. In the case of vibration, a mobile communication device may include a vibration motor that can be driven by a single direct current (DC) voltage. The motor may spin a shaft which has a counter weight that is not centered on the axis of the shaft, thus resulting in a vibration when spun. Hardware of the device can be configured to apply power to the vibration motor such that the mobile communication device vibrates sufficiently for notifying the user of an incoming communication or other information.

In certain instances, a mobile communication device may be placed on a table or other surface when it is not being carried by its user. A problem may be encountered if the device vibrates and moves towards an edge of the table due to the vibratory motion. In such cases, the device may fall off the table edge if the vibration does not stop in time or it is not otherwise prevented from falling. For at least this reason, it is desired to provide techniques for preventing such movements of the device.

### BRIEF SUMMARY

Disclosed herein are systems and methods for altering movement of mobile communication devices based on determined movements. According to an aspect, a method may include determining movement of a mobile communication device. The method may also include determining whether the movement of the mobile communication device meets a predetermined criterion. Further, the method may include controlling a mechanism of the mobile communication device for altering movement of the mobile communication device in response to determining that the movement meets the predetermined criterion.

### BRIEF DESCRIPTION OF THE SEVERAL VIEWS OF THE DRAWINGS

FIG. 1 is a block diagram of a smartphone for altering its movement in accordance with embodiments of the present invention;

FIG. 2 is a flow chart of an example method for altering movement of a mobile communication device in accordance with embodiments of the present invention; and

FIG. 3 is a flow chart of another example method for altering movement of a mobile communication device.

### DETAILED DESCRIPTION

The present invention is described with specificity to meet statutory requirements. However, the description itself is not intended to limit the scope of this patent. Rather, the disclosed subject matter may also be embodied in other ways, to include different steps or elements similar to the ones described in this document, in conjunction with other present or future technologies.

As referred to herein, the term “electronic device” should be broadly construed. It can include any type of mobile communication device, for example, a smartphone, a mobile telephone, a pager, a personal digital assistant (PDA, e.g., with GPRS NIC), a mobile computer with a smart phone client, or the like. An electronic device can also include any type of conventional computer, for example, tablet computer or a notebook computer. Electronic devices may include a user interface for presenting information to a user and for receiving information from a user. An electronic device may include a vibration generator configured to be controlled to impart a vibratory motion on the electronic device. The vibration generator may be activated in response to a notification for attention of the user. For example, the vibration generator may be activated in response to receipt of an incoming call, email, text message, or the like. Although many of the examples provided herein are implemented on a smartphone, the examples may similarly be implemented on any suitable electronic device.

As referred to herein, a “user interface” is generally a system by which users interact with a computing device. A user interface can include an input for allowing users to manipulate an electronic device, and can include an output for allowing the system to present information and/or data, indicate the effects of the user's manipulation, etc. An example of a user interface on an electronic device (e.g., a smartphone) includes a graphical user interface (GUI) that allows users to interact with programs in more ways than typing.

As referred to herein, an “accelerometer” may be any equipment or component capable of measuring acceleration. This acceleration may be proper acceleration, the acceleration experienced relative to freefall. For example, an accelerometer may be a single- or multi-axis accelerometer configured to detect magnitude and direction of the acceleration as a vector quantity, and can be used to sense orientation, acceleration, vibration shock, or falling. A micromachined accelerometer may be provided in an electronic device, and may output a signal indicating the acceleration measurements.

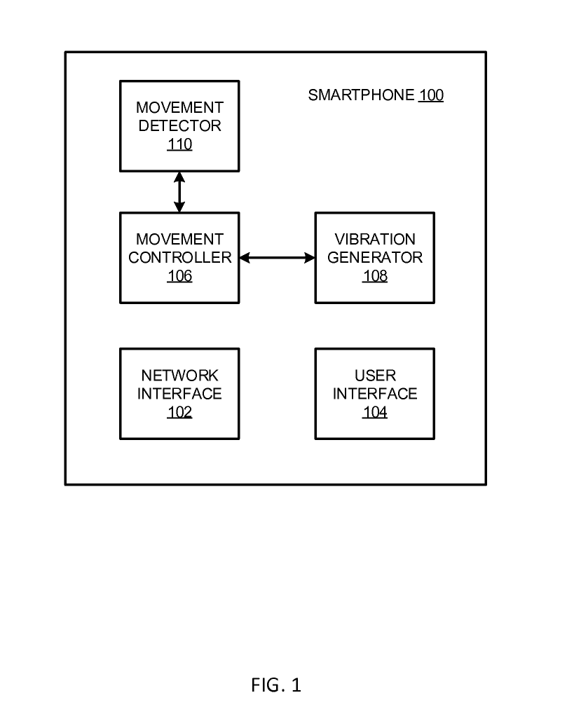

The present invention is now described in more detail. For example, FIG. 1 illustrates a block diagram of a smartphone 100 for altering its movement in accordance with embodiments of the present invention. Although a smartphone is used in examples provided herein, it should be recognized that the techniques and systems described herein may be similarly applied to any other mobile communication device. The smartphone 100 may include a network interface configured for communicating with a wireless network, such as a 2.5G network, a 3G network, or a 4G network. The smartphone 100 may be configured to operate in other and next-generation mobile networks as well. The smartphone 100 may be the equipment used by the end user, typically a subscriber to the wireless network. The smartphone 100 may include a network interface 102 configured to communicate with the wireless network. For example, the network interface 102 may be configured to receive and to communicate incoming calls, text messages, Internet data, and the like. The smartphone 100 may include a user interface 104 including, but not limited to, a touchscreen display, one or more buttons, an image capture device (e.g., a camera), one or more speakers, a microphone, and the like.

The smartphone 100 may include a movement controller 106 configured to determine movement of a mobile communication device, to determine whether the movement of the mobile communication device meets a predetermined criterion, and to control a mechanism of the mobile communication device for altering movement of the mobile communication device in response to determining that the movement meets the predetermined criterion. The movement controller 106 may be implemented by hardware, software, firmware, or combinations thereof. For example, the movement controller 106 may include one or more processors and memory including instructions for read and implementation by the processor(s).

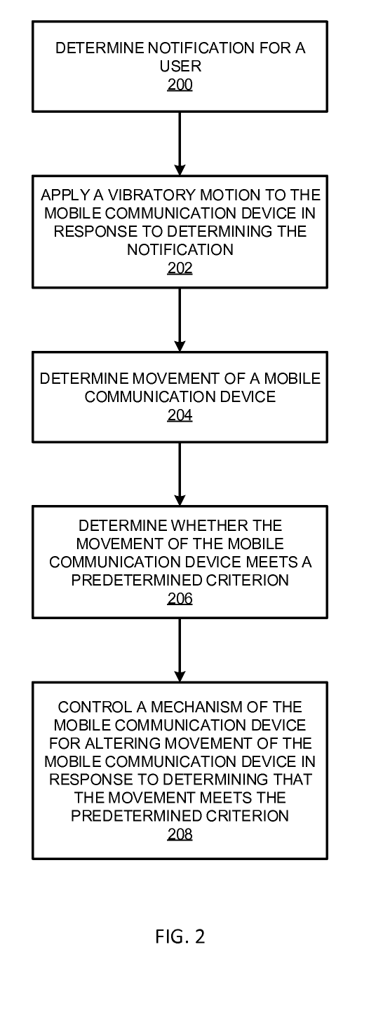

FIG. 2 illustrates a flow chart of an example method for altering movement of a mobile communication device in accordance with embodiments of the present invention. The example method is described as being implemented by the smartphone 100 shown in FIG. 1, although it should be understood that the method may be implemented by any suitable mobile communication device. For example, the method may be suitably and similarly implemented by a tablet computer, a notebook computer, an e-reader, any other type of mobile telephone, or the like.

Referring now to FIG. 2, the method includes determining 200 notification for a user. For example, the network interface 102 of the smartphone 100 may receive an incoming call or text message. In another example, the network interface 102 may receive a notification (e.g., a news alert or a social network message) associated with an application residing on the smartphone 100. The movement controller 106 may be configured to receive and determine an occurrence of the notification.

The method of FIG. 2 includes applying 202 a vibratory motion to the mobile communication device in response to determining the notification. Continuing the aforementioned example, the movement controller 106 may control a vibration generator 108 to apply a vibratory motion to the smartphone 100 in response to determining a notification, such as an incoming call or text message. In this way, the smartphone 100 may vibrate to thereby alert a user to the notification. A user may interact with the user interface 104 for changing notification settings, such as when the smartphone 100 is to vibrate based on particular notifications.

The vibration generator 108 may include suitable electronic and mechanical components for imparting a vibratory motion on the smartphone 100. For example, the vibration generator 108 may include a vibration motor that can be driven by a single DC voltage. The motor may spin a shaft which has a counter weight that is not centered on the axis of the shaft, thus resulting in a vibration when spun. The movement controller 106 can be configured to apply power and/or a drive signal to the vibration motor to activate for vibrating the smartphone 100. The movement controller 106 may be configured to control the activation and de-activation of the vibration motor. Further, for example, the movement controller 106 may be configured to control a speed of rotation or a specific frequency of the vibration motor. As an example, the vibration generator 108 may include a frequency generator configured to drive the motor at a predetermined frequency. In another example, the movement controller 106 may be configured to control the motor to turn the shaft in one direction as well as the opposing direction, and at variable rotation speeds in each direction.

The method of FIG. 2 includes determining 204 movement of an mobile communication device. Continuing the aforementioned example, the smartphone 100 may include a movement detector 100 configured to detect a movement of the smartphone 100. The movement detector 100 may include an accelerometer, global positioning system (GPS) device, or other device capable to detect movement and/or a change of movement of the smartphone 100. The movement generator 100 may generate, in response to detecting the movement and/or movement change, an output signal that indicates the direction and/or speed of the movement. The movement controller 106 may receive the output signal or another indicator of the detected movement and/or movement change. For example, the movement data may indicate a magnitude of the movement (e.g., a speed of the movement), a direction of the movement, and/or an acceleration.

The method of FIG. 2 includes determining 206 whether the movement of the mobile communication device meets a predetermined criterion. Continuing the aforementioned example, the movement controller 106 may determine whether the detected movement of the smartphone 100 meets a predetermined criterion. For example, the movement controller 106 may determine, based on output of the movement detector 110, that the smartphone 100 is moving substantially along a line or substantially along a plane for a predetermined distance. In such a scenario, it may be assumed that the smartphone is moving along a surface, such as a table, and therefore there may be at risk to fall off an edge of the table if the smartphone moves beyond a predetermined distance.

The method of FIG. 2 includes controlling 208 a mechanism of the mobile communication device for altering movement of the mobile communication device in response to determining that the movement meets the predetermined criterion. Continuing the aforementioned example, the movement controller 106 may control the vibration generator 108 or another component of the smartphone 100 to alter movement of the smartphone 100 in response to determining that the smartphone 100 is moving substantially along a line or plane for a predetermined distance. For example, the movement controller 106 may control the vibration generator 108 to apply a vibratory motion to the smartphone 100. In an example, the movement controller 106 may control the vibration generator 108 to reduce application for the vibratory motion to the mobile communication device in response to determining that the detected movement meets the predetermined criterion. For example, an intensity and/or duration of application of the vibratory motion may be reduced by control of the movement controller 106. In another example, the movement controller 106 may control the vibration generator 108 to de-activate for stopping the vibratory motion. In this way, the detected movement of the smartphone 100 may be stopped based on the assumption that the vibratory motion generated by the vibration generator 108.

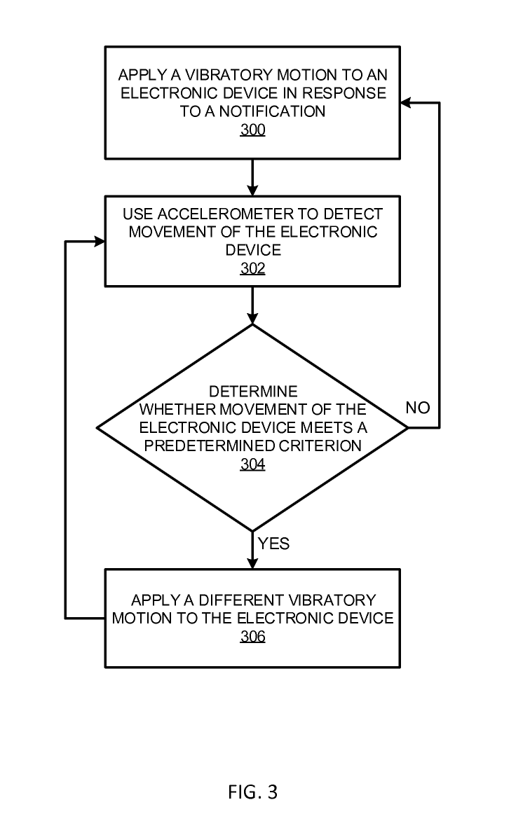

In accordance with embodiments of the present invention, FIG. 3 illustrates a flow chart of another example method for altering movement of a mobile communication device. The example method is described as being implemented by the smartphone 100 shown in FIG. 1, although it should be understood that the method may be implemented by any suitable mobile communication device. For example, the method may be suitably and similarly implemented by a tablet computer, a notebook computer, an e-reader, any other type of mobile telephone, or the like.

Referring now to FIG. 3, the method includes applying 300 a vibratory motion to a mobile communication device in response to a notification. For example, the movement controller 106 may control a vibration generator 108 to apply a vibratory motion to the smartphone 100 in response to determining a notification, such as an incoming call or text message. The movement controller 106 may be set to control the vibration generator 108 to vibrate at a particular level to provide an alert for the notification.

The method of FIG. 3 includes using 302 an accelerometer to detect movement of the mobile communication device. Continuing the aforementioned example, an accelerometer of the smartphone 100 may detect movement and/or a change of movement of the smartphone 100. The movement generator 100 may generate, in response to detecting the movement and/or movement change, an output signal that indicates the direction and/or speed of the movement. The movement controller 106 may receive the output signal. For example, the movement data may indicate a magnitude of the movement, a direction of the movement, and/or an acceleration.

The method of FIG. 3 includes determining 304 whether movement of the mobile communication device meets a predetermined criterion. Continuing the aforementioned example, the movement controller 106 may determine, based on output of the movement detector 110, that the smartphone 100 is moving substantially along a plane for a predetermined distance. In this scenario, it may be assumed that the smartphone is moving along a surface of a table.

In response to determining that the movement does not meet the predetermined criterion, the method may return to continue to apply 300 the same vibratory motion to the mobile communication device. For example, the vibration generator 108 may continue to provide a vibratory motion at the same level and frequency.

In response to determining that the movement meets the predetermined criterion, a different vibratory motion may be applied 306 to the mobile communication device. Continuing the aforementioned example, the movement controller 106 may control the vibration generator 108 to reduce application of the vibratory motion to the smartphone 100. In this way, by controlling the vibration generator 108, the smartphone 100 can be moved in another way. For example, it may be desired to move the smartphone 100 in a direction that opposes the direction caused by the application of a vibratory motion in step 300. Subsequent to step 306, the method may return to step 302 for entering the loop to detect movement of the mobile communication device (step 302) and determine (step 304) whether the mobile communication device continues to move in a way that meets the predetermined criterion. If needed, a different vibratory motion can subsequently be applied to keep the movement of the mobile communication device from moving according to the predetermined criterion. In this manner, the mobile communication device may, for example, be prevented from falling off a table.

In accordance with embodiments of the present invention, a mobile communication device may determine whether its movement is in response to an applied vibratory motion. For example, the movement controller 106 may determine whether a detected movement along a line or plane is in response to vibration generated by the vibration generator 108. For example, the movement controller 106 may monitor movement as the vibration generator 108 is activated and de-activated. The movement controller 106 can determine whether the movement along the line or plane is responsive to the generated vibration. If the movement is determined to be based on the generated vibration, the movement controller 106 may control the vibration generator 108 to reduce vibration output. Alternatively, the vibration generator 108 may be controlled to de-activate or otherwise change its output as a corrective action to prevent the mobile communication device's continued movement along the line or plane.

Example corrective actions include, but are not limited to, de-activating the vibration generator, decreasing a speed of rotation of a motor of the vibration generator, or altering a direction of rotation of the motor of the vibration generator. In response to determining that the movement of the mobile communication device has reversed, the motor may be reversed again. In response to determining that the direction of movement has stayed the same, the motor intensity may be reduced. If movement of the mobile communication device has ceased, the motor direction and intensity may be controlled to remain the same or substantially the same.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
determining activation and de-activation of a vibration generator that is controlled to activate based on a notification receipt for a user;
determining movement of a mobile communication device;
determining whether the movement of the mobile communication device meets a predetermined criterion and is in response to activation of the vibration generator; and
in response to determining that the movement meets the predetermined criterion and is in response to activation of the vibration generator, controlling a mechanism of the mobile communication device for altering movement of the mobile communication device.

2. The method of claim 1, wherein determining movement comprises determining movement of one of a tablet computer and a smartphone.

3. The method of claim 1, wherein determining movement comprises using one of an accelerometer and a global positioning system device to detect the movement of the mobile communication device.

4. The method of claim 1, wherein determining movement comprises determining movement of the mobile communication device in a first direction, and
wherein the method further comprising:
determining whether the mobile communication device moves in a second direction that opposed to the first direction in response to controlling the mechanism; and
in response to determining that the mobile communication device does not move in the second direction, controlling the mechanism to move the mobile communication device in another way.

5. The method of claim 1, wherein determining movement of a mobile communication device comprises determining movement of the mobile communication device along a plane.

6. The method of claim 1, wherein controlling a mechanism comprises controlling a vibration generator to apply a vibratory motion to the mobile communication device.

7. The method of claim 1, further comprising applying a vibratory motion to the mobile communication device.

8. The method of claim 7, wherein the mobile communication device comprises a motor and a counter weight, and
wherein applying a vibratory motion comprises controlling the motor to move the counter weight such that the mobile communication device vibrates.

9. The method of claim 1, further comprising applying a vibratory motion to the mobile communication device, and
wherein controlling a mechanism comprising reducing application of the vibratory motion to the mobile communication device in response to determining that the movement meets the predetermined criterion.

10. The method of claim 9, wherein reducing application of the vibratory motion comprises reducing one of an intensity and a duration of application of the vibratory motion.

11. The method of claim 1, further comprising:
determining a notification for a user; and
in response to determining the notification, applying a vibratory motion to the mobile communication device,
wherein determining movement comprises determining whether the movement is in response to the applied vibratory motion, and
wherein the method further comprises reducing application of the vibratory motion to the mobile communication device in response to determining that the movement is in response to the applied vibratory motion.

12. A mobile communication device comprising:
a mechanism configured to move the mobile communication device; and
a movement controller comprising at least one processor and memory configured to:
determine activation and de-activation of a vibration generator that is controlled to activate based on a notification receipt for a user;
determine movement of a mobile communication device;
determine whether the movement of the mobile communication device meets a predetermined criterion and is in response to activation of the vibration generator; and
control the mechanism to alter movement of the mobile communication device in response to determining that the movement meets the predetermined criterion and is in response to activation of the vibration generator.

13. The mobile communication device of claim 12, further comprising an accelerometer and a global positioning system device configured to detect the movement of the mobile communication device.

14. The mobile communication device of claim 12, wherein the movement controller is configured to:
determine movement of the mobile communication device in a first direction;
determine whether the mobile communication device moves in a second direction that opposed to the first direction in response to controlling the mechanism; and
control the mechanism to move the mobile communication device in another way in response to determining that the mobile communication device does not move in the second direction.

15. The mobile communication device of claim 12, wherein the movement controller is configured to determine movement of the mobile communication device along a plane.

16. The mobile communication device of claim 12, wherein the movement controller is configured to control a vibration generator to apply a vibratory motion to the mobile communication device.

17. The mobile communication device of claim 12, further comprising a motor and a counter weight, and
wherein the movement controller is configured to control the motor to move the counter weight such that the mobile communication device vibrates.

18. The mobile communication device of claim 12, wherein the movement controller is configured to:
apply a vibratory motion to the mobile communication device; and
reduce application of the vibratory motion to the mobile communication device in response to determining that the movement meets the predetermined criterion.

19. The mobile communication device of claim 18, wherein the movement controller is configured to reduce one of an intensity and a duration of application of the vibratory motion.

20. The mobile communication device of claim 12, wherein the movement controller is configured to:
determine a notification for a user;
apply a vibratory motion to the mobile communication device in response to determining the notification;
determine whether the movement is in response to the applied vibratory motion; and
reduce application of the vibratory motion to the mobile communication device in response to determining that the movement is in response to the applied vibratory motion.
